(19) United States
(12) Patent Application Publication
(10) Pub. No.: US 2022/0111736 A1
(43) Pub. Date: Apr. 14, 2022

(54) CONTROL DEVICE FOR ELECTRIFIED VEHICLE

(71) Applicant: TOYOTA JIDOSHA KABUSHIKI KAISHA, Toyota-shi Aichi-ken (JP)

(72) Inventors: Takuma Takeuchi, Susono-shi Shizuoka-ken (JP); Naoto Shimoya, Toyota-shi Aichi-ken (JP); Etsuo Katsuyama, Hiratsuka-shi Kanagawa-ken (JP)

(73) Assignee: TOYOTA JIDOSHA KABUSHIKI KAISHA, Toyota-shi Aichi-ken (JP)

(21) Appl. No.: 17/485,896

(22) Filed: Sep. 27, 2021

(30) Foreign Application Priority Data
Oct. 13, 2020 (JP) 2020-172571

(51) Int. Cl. B60L 15/20; B60W 10/08; B60C 3/04

(52) U.S. Cl. CPC B60L 15/20; B60W 10/08; B60Y 2200/91; B60L 2240/423; B60W 2710/083; B60C 3/04

(57) ABSTRACT

A control device of an electrified vehicle controls a drive motor that drives a tire-wheel assembly of a vehicle based on a torque target value set based on a state of the vehicle. A control device includes a torque command value calculation unit that calculates a torque command value based on a torque target value using a function representing inverse characteristics of transmission characteristics that represent a relationship between torque of a drive motor and acceleration of a vehicle body and that change according to a speed of a vehicle, which is caused by elasticity of a carcass portion of a tire of a tire-wheel assembly and viscosity in a tread of the tire, and a motor controller that controls the drive motor to output torque corresponding to the torque command value.

### CROSS-REFERENCE TO RELATED APPLICATION

This application claims priority to Japanese Patent Application No. 2020-filed on Oct. 13, 2020, incorporated herein by reference in its entirety.

### BACKGROUND

### 1. Technical Field

The present disclosure relates to a control device for an electrified vehicle.

### 2. Description of Related Art

In the related art, a control device for an electrified vehicle that controls a drive motor configured to drive vehicle tires based on a torque target value set based on a vehicle state has been known (for example, Japanese Unexamined Patent Application Publication No. 2017-225278 (JP 2017-225278A). In particular, in the control device described in JP 2017-225278A, a torque command value to the drive motor is calculated from the torque target value to suppress torsional vibration in a drive shaft, and the drive motor is controlled to output torque corresponding to the calculated torque command value.

### SUMMARY

Meanwhile, a tire that transmits vehicle power to a road surface has viscoelasticity between a wheel fixing portion of the tire connected to a wheel and a tread surface of the tire in contact with the road surface. Therefore, the viscoelasticity may also cause vibration in a vehicle as the vehicle travels. However, the control device described in JP 2017-225278A does not consider the viscoelasticity of the tire. As a result, the vibration of the vehicle due to the viscoelasticity of the tire cannot be suppressed.

The present disclosure is to provide a control device for an electrified vehicle capable of suppressing vibration of a vehicle due to viscoelasticity of a tire.

The gist of this disclosure is as follows.

[1] A first aspect of the present disclosure relates to a control device for an electrified vehicle that controls a drive motor configured to drive a tire-wheel assembly based on a torque target value set based on a state of a vehicle, including a torque command value calculation unit and a motor controller.

The torque command value calculation unit calculates a torque command value based on the torque target value using a function representing inverse characteristics of transmission characteristics that represent a relationship between torque of the drive motor and acceleration of a vehicle body and that change according to a speed of the vehicle, which is caused by elasticity of a carcass portion of a tire of the tire-wheel assembly and viscosity in a tread of the tire.

The motor controller controls the drive motor to output torque corresponding to the torque command value.

[2] In the control device for the electrified vehicle according to [1], the transmission characteristics represent the relationship between the torque of the drive motor and the acceleration of the vehicle body, which is caused by viscoelasticity of a suspension device between the vehicle body and the tire-wheel assembly in addition to the elasticity in the carcass portion of the tire and the viscosity in the tread of the tire.

[3] In the control device for the electrified vehicle according to [1] or [2], a relationship between torque Tₘ of the drive motor and acceleration x_{b}″ of the vehicle body in the transmission characteristics is represented by the following equation (1),

$$\frac{{\ddot{x}}_{b}}{{T}_{m}} = \frac{{n}_{2} {s}^{2} + {n}_{1} s + {n}_{0}}{{d}_{4} {s}^{4} + {d}_{3} {s}^{3} + {d}_{2} {s}^{2} + {d}_{1} s + {d}_{0}} \qquad ( 1 )$$

in equation (1), s is a complex parameter of the Laplace transform, nᵢ (i=0, 1, 2) and dⱼ (j=0, 1, 2, 3, 4) are coefficients, and at least a part of nᵢ or dⱼ changes according to the speed of the vehicle, and the coefficients nᵢ and dⱼ in equation (1) are calculated based on the following equations (2) and (3),

$$\begin{matrix}{F}_{d} = - {D}_{s} ( \frac{1}{1 + \frac{{D}_{s}}{V {k}_{c}} s} ) \frac{( \dot{x} - {\dot{x}}_{w} )}{V} & ( 2 ) \\ {l}_{w} {\ddot{θ}}_{w} = {T}_{m} - {F}_{d} & ( 3 )\end{matrix}$$

in equations (2) and (3), F_{d} is driving force of the tire, Dₛ is driving stiffness of the tire, V is a speed of a vehicle, x′−x_{w}′ is a relative speed of a tread surface with respect to a wheel fixing portion of the tire, I_{w} is moment of inertia of the tire-wheel assembly, and θ_{w}″ is angular acceleration of the tire-wheel assembly.

[4] In the control device for the electrified vehicle according to [3], the coefficients nᵢ and dᵢ in equation (1) are calculated based on the following equations (4) and (5) in addition to equations (2) and (3),

mᵤ\ddot{x}ᵤ=F_{d}−Kₓ(xᵤ−x_{b})−Cₓ(\dot{x}ᵤ−\dot{x}_{b}) (4)

m_{b}\ddot{x}_{b}=Kₓ(xᵤ−x_{b})+Cₓ(\dot{x}ᵤ−\dot{x}_{b}) (5)

in equations (4) and (5), mᵤ is a weight of an unsprung portion, m_{b} is a weight of a vehicle body, Kₓ is an elastic coefficient of a suspension device between the vehicle body and the tire, Cₓ is a viscosity coefficient of the suspension device, xᵤ, xᵤ′, and xᵤ″ are a displacement, a speed, and acceleration of the unsprung portion, respectively, and x_{b}, x_{b}′, and x_{b}″ are a displacement, a speed, and acceleration of the vehicle body, respectively.

[5] In the control device for the electrified vehicle according to any one of [1] to [4], the inverse characteristics are represented by the following equation (6) representing the relationship between the torque target value Tₘₜ and the torque command value Tₘᵢ,

$${T}_{mi} = \frac{{d}_{4} {s}^{4} + {d}_{3} {s}^{3} + {d}_{2} {s}^{2} + {d}_{1} s + {d}_{0}}{{n}_{2} {s}^{2} + {n}_{1} s + {n}_{0}} {T}_{mt} \qquad ( 6 )$$

in equation (6), s is a complex parameter of the Laplace transform, nᵢ (i=0, 1, 2) and dⱼ (j=0, 1, 2, 3, 4) are coefficients, and at least a part of nᵢ or dⱼ changes according to the speed of the vehicle.

The torque command value calculation unit inputs the torque target value into a function obtained by multiplying equation (6) by a second-order low-pass filter of a complex parameter s that makes the inverse characteristics represented by equation (6) proper to calculate the torque command value.

According to the present disclosure, there is provided the control device for the electrified vehicle capable of suppressing the vibration of the vehicle due to the viscoelasticity of the tire.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram schematically showing an electrified vehicle equipped with a control device according to one embodiment;

FIG. 2 is a hardware configuration diagram of an ECU;

FIG. 3 is a functional block diagram of an ECU processor relating to control of a drive motor;

FIG. 4 is a diagram showing a physical model of a drive wheel;

FIG. 5 is a diagram schematically showing a system model for a drive system;

FIG. 6 is a diagram showing actual measurement values of frequency response characteristics in an experimental vehicle when vehicle speeds are 0 km/h and 60 km/h;

FIG. 7 is a diagram showing transmission characteristics represented by equation (19) as frequency response characteristics when the vehicle speeds are 0 km/h and 60 km/h; and

FIG. 8 is a diagram showing frequency response characteristics showing a result of an experiment on vibration suppression.

### DETAILED DESCRIPTION OF EMBODIMENTS

Hereinafter, embodiments will be described in detail with reference to drawings. In the following description, the same reference number is assigned to a similar component.

Configuration of Electrified vehicle

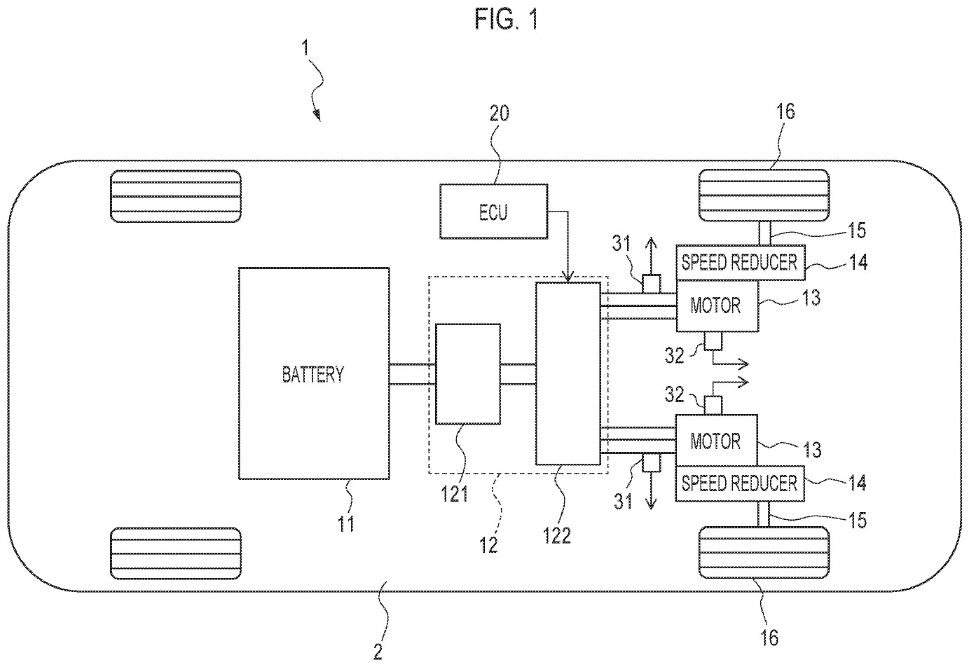

FIG. 1 is a diagram schematically showing an electrified vehicle 1 equipped with a control device according to one embodiment. In the present embodiment, the electrified vehicle 1 shown in FIG. 1 is an electric vehicle in which a vehicle is driven solely by a drive motor, but may be a hybrid vehicle in which the vehicle is driven by both a drive motor and an internal combustion engine.

In the electrified vehicle 1 of the present embodiment, tire-wheel assemblies are supported by a suspension device, and a weight of the tire-wheel assemblies, a brake, and the like located below the suspension device is referred to as an unsprung weight. In the present specification, a portion of the electrified vehicle 1 located above the suspension device is referred to as a vehicle body 2, and thus a weight of the vehicle body 2 (spring weight) means a weight obtained by subtracting the unsprung weight from a weight of the entire electrified vehicle 1.

As shown in FIG. 1, the electrified vehicle 1 has a battery 11, a power control unit (PCU) 12, drive motors 13, speed reducers 14, drive shafts 15, and drive wheels (tire-wheel assemblies) 16, as components configured to drive the vehicle. In particular, in the electrified vehicle 1 of the present embodiment, one drive motor 13 is provided for each of two drive wheels 16 (in-wheel motor). However, one drive motor may be provided for a plurality of the drive wheels 16.

The battery 11 is an example of a device capable of storing electricity and discharging the stored electricity, and is, for example, a rechargeable secondary battery, such as a lithium ion battery. The battery 11 is electrically connected to the PCU 12. An external charger is connected to the battery 11 for charging. When the electrified vehicle 1 is a hybrid vehicle, electric power generated by driving a generator with driving force of the internal combustion engine is supplied to charge the battery 11. In addition, when a motor generator is used as the drive motor, regenerative electric power from the motor generator is supplied to charge the battery 11. The electric power charged in the battery 11 is supplied to the drive motors 13 through the PCU 12 in order to drive the electrified vehicle 1 and is supplied to an electrical device, such as an air conditioning device or a navigation system, which is mounted on the electrified vehicle 1 and is used other than for the driving of the electrified vehicle 1, as needed.

The PCU 12 is an example of a device used to electrically control the drive motors 13. The PCU 12 is electrically connected to the battery 11 and is electrically connected to the drive motors 13. The PCU 12 controls the drive motors 13 with the electric power supplied from the battery 11, based on a control signal from an electronic control unit (ECU) 20 described below. In the present embodiment, the PCU 12 includes a converter 121 and an inverter 122.

The converter 121 is, for example, a bidirectional DC/DC converter. The converter 121 steps up a voltage of the battery 11 in order to supply the electric power of the battery 11 to the drive motors 13 to drive the electrified vehicle 1 and supplies the stepped-up electric power to the inverter 122. When the motor generator is used as the drive motor 13, the converter 121 steps down the regenerative electric power in order to supply the regenerative electric power to the battery 11 and supplies the stepped-down electric power to the battery 11.

The inverter 122 turns on or off a switching element to convert a direct current supplied from the converter 121 into an alternating current and causes the alternating current to flow into the drive motors 13. In particular, in the present embodiment, three-phase alternating currents flow into the drive motors 13. The inverter 122 substantially changes a frequency and amplitude of an alternating voltage applied to the drive motor 13 by a method such as pulse width modulation (PWM) based on the control signal from the ECU 20 to control a rotation speed of the drive motor 13 and torque (output torque) output by the drive motor 13. When the motor generator is used as the drive motor 13, the inverter 122 converts an alternating current supplied from the motor generator into a direct current and causes the direct current to flow into the battery 11 through the converter 121.

The drive motor 13 is an example of an electric motor that drives the tire-wheel assembly of the electrified vehicle 1, and is, for example, a three-phase alternating current electric motor. The drive motor 13 may be a motor generator that functions as a generator that generates the regenerative electric power by regenerative electric power generation during braking of the vehicle. The drive motors 13 are electrically connected to the inverter 122, and the three-phase alternating currents flow from the inverter 122 into the drive motors 13. The drive motors 13 drive the electrified vehicle 1 when the power is supplied from the battery 11 through the PCU 12. When the drive motor 13 functions as the motor generator, the regenerative electric power is generated during braking of the electrified vehicle 1 and is supplied to the battery 11 through the PCU 12.

In particular, in the present embodiment, one drive motor 13 is provided for each of the two drive wheels 16. Therefore, the electrified vehicle 1 includes two drive motors 13. Each of the drive motors 13 is connected to the inverter 122 and is controlled independently of each other.

The speed reducer 14 and the drive shaft 15 transmit the driving force output from the drive motor 13 to the drive wheel 16. The speed reducer 14 is connected to an output shaft of the drive motor 13 and is connected to the drive wheel 16 through the drive shaft 15. The speed reducer 14 reduces an output of the drive motor 13 at a constant reduction ratio, and the drive shaft 15 transmits an output of the speed reducer 14 to the drive wheel 16.

The drive wheel 16 is a tire-wheel assembly that transmits the power from the drive motor 13 to the road surface. The drive wheel 16 is connected to the drive shaft 15 and rotates as the drive shaft 15 rotates. The drive wheel 16 has a wheel connected to the drive shaft 15 and a tire fixed to an outer circumference of the wheel, and the tire transmits the power to the road surface.

As shown in FIG. 1, the electrified vehicle 1 includes the electronic control unit (ECU) 20 that controls the electrified vehicle 1, a current sensor 31, and a rotation phase sensor 32.

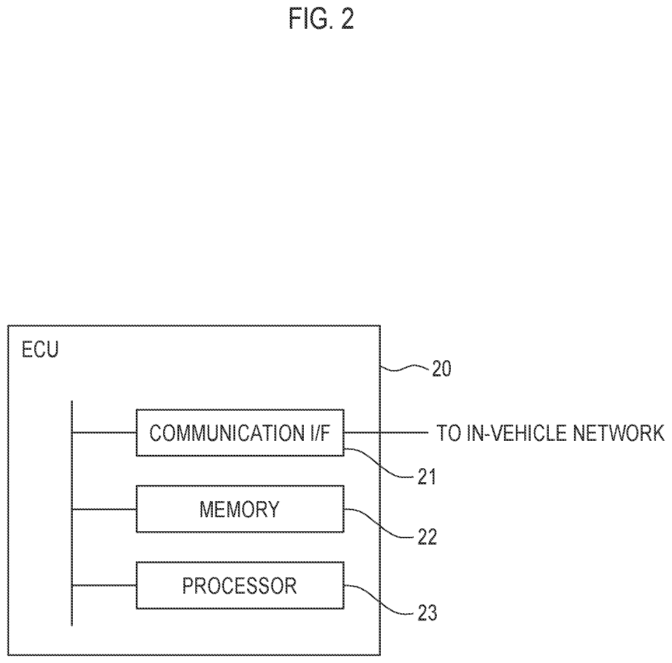

The ECU 20 is an example of a control device used to control the drive motor 13. In addition, the ECU 20 is also used to control other electronic devices of the electrified vehicle 1. FIG. 2 is a hardware configuration diagram of the ECU 20. As shown in FIG. 2, the ECU 20 has a communication interface 21, a memory 22, and a processor 23. The communication interface 21 and the memory 22 are connected to the processor 23 through a signal line. In the present embodiment, the electrified vehicle 1 is provided with one ECU 20, but a plurality of ECUs divided for each function may be provided.

The communication interface 21 has an interface circuit that connects the ECU 20 to an in-vehicle network conforming to a standard, such as a controller area network (CAN). The ECU 20 communicates with other in-vehicle devices through the communication interface 21. Specifically, the communication interface 21 is connected to the inverter 122, the current sensor 31, and the rotation phase sensor 32 through, for example, the in-vehicle network. The ECU 20 transmits the control signal to the inverter 122 and receives output signals of the current sensor 31 and the rotation phase sensor 32.

The memory 22 is an example of a storage unit that stores data. Examples of the memory 22 include a volatile semiconductor memory (such as RAM) and a non-volatile semiconductor memory (such as ROM). The memory 22 stores a computer program for executing various pieces of processing in the processor 23, various data used when the various pieces of processing are executed by the processor 23, and the like.

The processor 23 is an example of a processing device that performs arithmetic processing for controlling the electronic device, such as the drive motor 13. The processor 23 has one or more central processing units (CPUs) and peripheral circuits thereof. The processor 23 may further have a graphics processing unit (GPU) or an arithmetic circuit, such as a logical arithmetic unit or a numerical arithmetic unit. The processor 23 executes the various pieces of processing based on the computer program stored in the memory 22.

The current sensor 31 is an example of a detector that detects a current flowing from the inverter 122 into each of the drive motors 13. In the present embodiment, each of the current sensors 31 detects the three-phase alternating currents flowing through each drive motor 13. However, each of the current sensors 31 may detect any two-phase alternating currents and estimate a remaining one-phase alternating current from the two-phase alternating currents.

The rotation phase sensor 32 is an example of a detector that detects a rotation phase of each of the drive motors 13. The rotation phase sensor 32 is, for example, a resolver or an encoder.

Control of Drive Motor

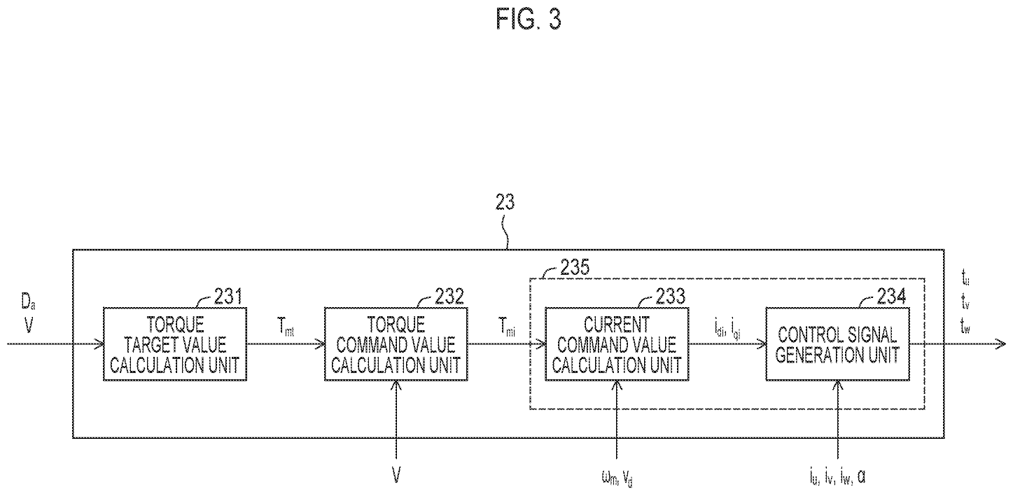

Next, the control of the drive motor 13 will be described with reference to FIG. 3. In controlling the drive motor 13, PWM signals (three-phase pulse width signals) are generated in the processor 23 of the ECU 20, and the PWM signals are transmitted to the inverter 122 through the communication interface 21 of the ECU 20. In the following, a method of generating the PWM signal in the processor 23 will be described. In the following, a case where the drive motor 13 is controlled by vector control will be particularly described as an example.

FIG. 3 is a functional block diagram of the processor 23 of the ECU 20 related to the control of the drive motor 13. The processor 23 has a torque target value calculation unit 231, a torque command value calculation unit 232, a current command value calculation unit 233, and a control signal generation unit 234. The functional blocks of the processor 23 are, for example, functional modules realized by the computer program operating on the processor 23. The functional blocks may be dedicated arithmetic circuits provided in the processor 23. In the following, the current command value calculation unit 233 and the control signal generation unit 234 are collectively referred to as a motor controller 235.

The torque target value calculation unit 231 calculates a torque target value Tₘₜ based on a state of the electrified vehicle 1. The torque target value calculation unit 231 receives a value of a parameter related to the state of the electrified vehicle 1. The torque target value calculation unit 231 outputs a torque target value suitable for a current state of the electrified vehicle 1 to the torque command value calculation unit 232.

In the present embodiment, a depression amount Dₐ of an accelerator pedal and a speed V of the electrified vehicle 1 are used as parameters related to the state of the electrified vehicle 1 in the torque target value calculation unit 231. Therefore, the torque target value calculation unit 231 calculates the torque target value Tₘₜ based on the parameters. The depression amount Dₐ of the accelerator pedal is detected by, for example, a depression amount sensor (not shown) that outputs a voltage corresponding to a depression amount of an accelerator pedal. For example, the rotation speed of the drive motor 13 calculated based on the output of the rotation phase sensor 32 is multiplied by a radius of the drive wheel 16 and is divided by a reduction ratio of the speed reducer to calculate the speed of the electrified vehicle 1. The rotation speed (angular velocity) of the drive motor 13 is calculated by differentiating the rotation phase of the drive motor 13 detected by the rotation phase sensor 32. The speed V of the electrified vehicle 1 may be obtained by another method, for example, a calculation based on the rotation speed of the drive wheel 16 calculated based on the output of the rotation phase sensor or the like provided on the drive shaft 15.

In calculating the torque target value Tₘₜ, another parameter may be used in place of or in addition to the depression amount Dₐ of the accelerator pedal and the speed V of the electrified vehicle 1. For example, output torque of the internal combustion engine or the like is used in the case of the hybrid vehicle.

The torque command value calculation unit 232 calculates a torque command value Tₘᵢ based on the torque target value Tₘₜ and the speed V of the electrified vehicle 1. The torque command value calculation unit 232 receives the torque target value Tₘₜ and the speed V of the electrified vehicle 1 and outputs the torque command value Ti to the current command value calculation unit 233. As described below, the electrified vehicle 1 vibrates in an advancing direction due to viscoelasticity of the tires of the drive wheels 16 and viscoelasticity of the suspension device. Therefore, the torque command value calculation unit 232 corrects the torque target value Tₘₜ to suppress such vibration in the advancing direction of the electrified vehicle 1, and outputs the corrected value as the torque command value Tₘᵢ. A method of calculating the torque command value Ti in the torque command value calculation unit 232 will be described below.

The current command value calculation unit 233 calculates current command values i_{di}, i_{qi} (current command values when conversion from three-phase to two-phase and to a rotating coordinate system is performed in vector control) based on the torque command value Tₘᵢ. In the present embodiment, the current command value calculation unit 233 receives the torque command value Tₘᵢ, a rotation speed om of the drive motor, and a voltage value of a direct current voltage supplied from the converter 121 to the inverter 122 (hereinafter, referred to as “direct current voltage value”) v_{d}, and outputs the current command values i_{di}, i_{qi} to the control signal generation unit 234.

The current command value calculation unit 233 calculates the current command values i_{di}, i_{qi} based on the torque command value Tₘᵢ, the rotation speed om of the drive motor, and the direct current voltage value v_{d}. The current command value calculation unit 233, for example, obtains in advance the torque command value Tₘᵢ, the rotation speed om of the drive motor, and the direct current voltage value v_{d} and a map or a calculation equation representing a relationship between the d-axis current command value i_{di} and the q-axis current command value i_{qi}, and calculates the d-axis current command value i_{di} and the q-axis current command value i_{qi} using the map or the calculation equation.

The control signal generation unit 234 generates the PWM signal to be transmitted to the inverter 122 based on the d-axis current command value i_{di} and the q-axis current command value i_{qi}. The control signal generation unit 234 receives the d-axis current command value i_{di}, the q-axis current command value i_{qi}, three-phase alternating currents iᵤ, iᵥ, and i_{w} detected by the current sensor 31, and a rotation phase a (rad) of the drive motor detected by the rotation phase sensor 32, and outputs PWM signals tᵤ (%), tᵥ (%), and t_{w} (%) to be transmitted to the inverter 122.

Specifically, the control signal generation unit 234 generates the PWM signals such that actual d-axis current i_{da} and q-axis current i_{q}a match the d-axis current command value iii and the q-axis current command value i_{qi} calculated by the current command value calculation unit 233. Therefore, the control signal generation unit 234 first calculates the actual d-axis current i_{da} and q-axis current i_{q}a based on the three-phase alternating currents iᵤ, iᵥ, and i_{w} detected by the current sensor 31 and the rotation phase a of the drive motor 13 detected by the rotation phase sensor 32. Next, the control signal generation unit 234 calculates a d-axis voltage command value v_{di} from a deviation between the actual d-axis current i_{da} and the d-axis current command value i_{di}, and calculates a q-axis voltage command value v_{qi} from a deviation between the actual q-axis current i_{q}a and the q-axis current command value i_{qi}. The control signal generation unit 234 calculates three-phase alternating voltage command values vᵤ, vᵥ, and v_{w} based on the d-axis voltage command value v_{di}, the q-axis voltage command value v_{qi}, and the rotation phase a of the drive motor 13, and generates the PWM signals tᵤ, tᵥ, and t_{w} based on the calculated three-phase alternating voltage command values vᵤ, vᵥ, and v_{w}. The control signal generation unit 234 transmits the generated PWM signals to the inverter 122.

The inverter 122 turns on or off the switching element based on the PWM signals transmitted from the control signal generation unit 234 of the ECU 20. Accordingly, the drive motor 13 is driven with torque corresponding to the torque command value calculated by the torque command value calculation unit 232.

As described above, the current command value calculation unit 233 receives the torque command value Tₘᵢ and the like, and the control signal generation unit 234 generates the PWM signals for controlling the drive motor 13 such that the torque corresponding to the torque command value Tₘᵢ is output. Therefore, the motor controller 235 configured of the current command value calculation unit 233 and the control signal generation unit 234 controls the drive motor 13 such that the torque corresponding to the torque command value is output. In the present embodiment, the motor controller 235 controls the drive motor 13 by the vector control. However, the drive motor 13 may be controlled by any method as long as the drive motor 13 can be controlled such that the torque corresponding to the torque command value is output.

Vibration Suppression

Meanwhile, as described above, the electrified vehicle 1 vibrates in the advancing direction due to the viscoelasticity of the tires of the drive wheels 16 and the viscoelasticity of the suspension device. Therefore, the torque command value calculation unit 232 of the ECU 20 according to the present embodiment corrects the torque target value Tₘₜ set based on the state of the electrified vehicle 1 such that the vibration is canceled, and calculates the torque command value Tₘᵢ. In the following, a method of calculating the torque command value Tₘᵢ will be described.

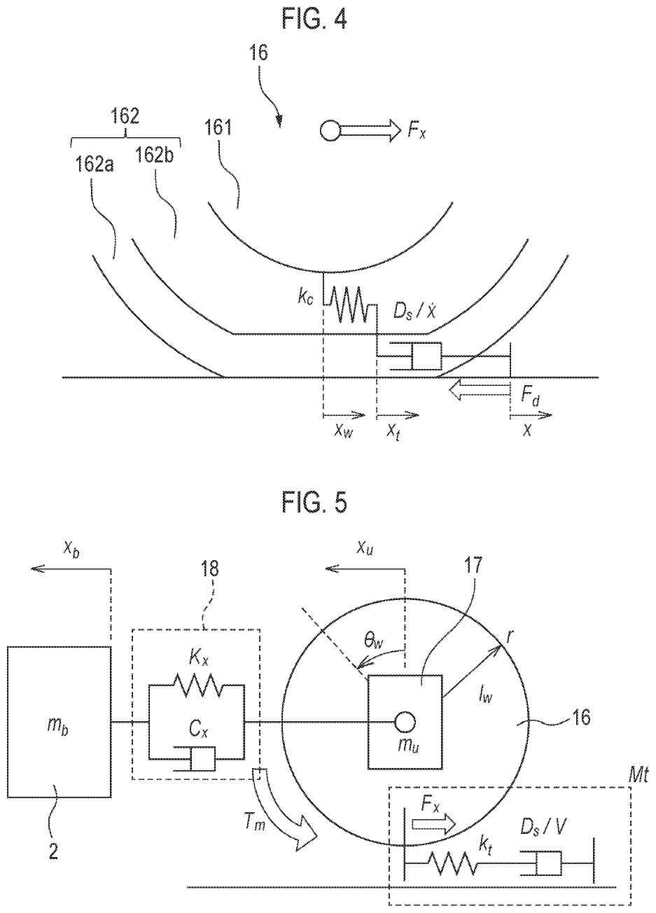

First, a physical model in consideration of the viscoelasticity of the tire is considered. FIG. 4 is a diagram schematically showing a physical model of the tire of the drive wheel 16. As shown in FIG. 4, the drive wheel 16 has a wheel 161 connected to the drive shaft 15 and a tire 162 fixed to the outer circumference of the wheel 161. The tire 162 includes a tread 162a that grounds the road surface and a carcass portion 162b that extends between the wheel 161 and the tread 162a. Therefore, the driving force from the drive wheels 16 is transmitted from the tread 162a to the road surface through the wheel 161 and the carcass portion 162b.

The tread 162a means a portion of the tire 162, which is formed of rubber without incorporating a cord, such as a steel cord. On the other hand, the carcass portion 162b means a portion of the tire 162 incorporating a cord, which is provided between the tread and a rim of the wheel 161 (including the carcass of the tire 162 and a belt).

As shown in FIG. 4, assuming that a displacement of the rim of the wheel 161 when viewed from the center of the wheel 161 is x_{w} and a displacement of a tread base between the tread 162a and the carcass portion 162b is xₜ, elastic restoring force Fₓ of the carcass portion 162b is represented by the following equation (7). Equation (7) represents that the elastic restoring force Fₓ of the carcass portion 162b depends on the elasticity of the carcass portion 162b. In equation (7), k_{c} is an elastic coefficient of the carcass portion 162b.

Fₓ=−k_{c}(xₜ−x_{w}) (7)

As shown in FIG. 4, assuming that a displacement of the road surface when viewed from the center of the wheel 161 is x, the driving force transmitted from the tread 162a of the tire 162 to the road surface (hereinafter, simply referred to as “tire driving force”) F_{d} is represented by the following equation (8). Equation (8) represents that the driving force F_{d} of the tire 162 depends on viscosity of the tread 162a. In equation (8), Dₛ is driving stiffness of the tread 162a and changes according to a ground area and tread rigidity.

$${F}_{d} = - \frac{{D}_{s}}{\dot{x}} ( \dot{x} - {\dot{x}}_{t} ) \qquad ( 8 )$$

The following equation (9) is obtained by differentiating equation (7), and the following equation (10) is obtained by substituting equation (9) into equation (8).

$$\begin{matrix}{\dot{F}}_{x} = - {k}_{c} ( {\dot{x}}_{t} - {\dot{x}}_{w} ) & ( 9 ) \\ {F}_{d} = - \frac{{D}_{s}}{\dot{x}} ( \dot{x} - {\dot{x}}_{w} + \frac{{\dot{F}}_{x}}{{k}_{c}} ) & ( 10 )\end{matrix}$$

When each of x′, xₜ′, and x_{w}′ of equation (9) is converted into a parameter representing a minute change amount at around the speed V of the electrified vehicle 1, equation (10) can be represented as the following equation (11) and equation (11) can be modified as the following equation (12). In the text of the present specification (excluding the equation), for convenience, a first differentiation of a certain parameter a is represented as a′ and a second differentiation thereof is represented by a″ (represented by a dot above the character in the equation).

$$\begin{matrix}{F}_{d} = - \frac{{D}_{s}}{V + \dot{x}} ( ( V + \dot{x} ) - ( V + {\dot{x}}_{w} ) + \frac{{\dot{F}}_{x}}{{k}_{c}} ) \\ ≅ - \frac{{D}_{s}}{V} ( \dot{x} - {\dot{x}}_{w} + \frac{{\dot{F}}_{x}}{{k}_{c}} )\end{matrix} \qquad \begin{matrix}( 11 ) \\ \begin{matrix} \\ ( 12 )\end{matrix}\end{matrix}$$

Considering equations (7) to (12) as a function of a complex parameter s after Laplace transform, Fₓ′=sFₓ, and F_{d}=Fₓ from force balance. Therefore, the following equation (13) can be obtained by modifying equation (12) using the relationships.

$${F}_{d} = - {D}_{s} ( \frac{1}{1 + \frac{{D}_{s}}{V {k}_{c}} s} ) \frac{( \dot{x} - {\dot{x}}_{w} )}{V} \qquad ( 13 )$$

As can be seen from equation (13), in the physical model of the drive wheel 16 shown in FIG. 4, the driving force F_{d} of the tire 162 is a first-order lag response depending on the speed V of the electrified vehicle 1 with respect to a difference between the speed x_{w}′ of the rim of the wheel 161 and the speed x′ of the road surface (that is, a relative speed of the tread surface with respect to the wheel fixing portion of the tire 162).

The following equation (14) is obtained when V=0 in equation (13), and the following equation (15) is obtained when V=∞ in equation (13).

$$\begin{matrix}{F}_{d} {\vert}_{V = 0} = - {k}_{c} ( \dot{x} - {\dot{x}}_{w} ) & ( 14 ) \\ {F}_{d} {\vert}_{V = ∞} = - \frac{{D}_{s}}{V} ( \dot{x} - {\dot{x}}_{w} ) s & ( 15 )\end{matrix}$$

As can be seen from equation (14), the driving force F_{d} of the tire 162 is dominated by the restoring force of a spring of the carcass portion 162b when the speed of the electrified vehicle 1 is low. As can be seen from equation (15), the driving force F_{d} of the tire 162 is dominated by the front-rear force due to slip when the speed of the electrified vehicle 1 is high. The above represents that a resonance mode of the tire 162 has dependency on the speed of the electrified vehicle 1.

Next, a system model for a drive system in consideration of the viscoelasticity of the suspension device between the vehicle body 2 and the drive wheels 16 is considered. FIG. 5 is a diagram schematically showing the system model for the drive system. In FIG. 5, m_{b} is the weight of the vehicle body 2 (spring weight), and mᵤ represents a weight of a portion (tire-wheel assemblies, brake, and the like. Hereinafter, referred to as “unsprung portion”) 17 of the electrified vehicle 1 located below the suspension device (unsprung weight). In FIG. 5, x_{b} represents a displacement of the vehicle body 2 in the advancing direction of the vehicle body 2, and xᵤ represents a displacement of the unsprung portion in the advancing direction of the vehicle body 2.

In FIG. 5, Kₓ represents an elastic coefficient of a spring of a suspension device 18, and Cₓ represents a viscosity coefficient of a shock absorber of the suspension device 18. Further, r represents a radius of the tire 162, I_{w} represents moment of inertia of each drive wheel (tire-wheel assembly) 16, and θ_{w} represents the rotation phase (that is, a rotation phase of the tire 162) of each drive wheel (tire-wheel assembly) 16 (therefore, θ_{w}″ represents angular acceleration of each drive wheel 16). Further, Mt in FIG. 5 schematically represents a physical model of the tire 162 shown in FIG. 4. In the system model for the drive system, the drive motor 13 is provided for each of the drive wheels 16. Therefore, rigidity of the drive system from the drive motor 13 to the drive wheel 16 is assumed to be sufficiently high.

In the system model for the drive system shown in FIG. 5, an equation of motion related to the rotation of the drive wheels 16 is represented by the following equation (16). In equation (16), Tₘ represents torque applied to the drive wheel 16, that is, torque of the drive motor 13. As described above, F_{d} in equation (16) is equal to Fₓ from the force balance.

I_{w}\ddot{θ}_{w}=Tₘ−rFₓ (16)

An equation of motion of the unsprung portion 17 and an equation of motion of the vehicle body 2 are represented by the following equations (17) and (18), respectively.

mᵤ\ddot{x}ᵤ=Fₓ−Kₓ(xᵤ−x_{b})−Cₓ(\dot{x}ᵤ−\dot{x}_{b}) (17)

m_{b}\ddot{x}_{b}=Kₓ(xᵤ−x_{b})+Cₓ(\dot{x}ᵤ−\dot{x}_{b}) (18)

When equation (13) and equations (16) to (18) are arranged as the function of the complex parameter s after the Laplace transform, a transmission function representing a relationship between the torque Tₘ of the drive motor 13 and acceleration x_{b}″ in the advancing direction of the vehicle body 2 is obtained as shown in the following equation (19).

$$\frac{{\ddot{x}}_{b}}{{T}_{m}} = \frac{{n}_{2} {s}^{2} + {n}_{1} s + {n}_{0}}{{d}_{4} {s}^{4} + {d}_{3} {s}^{3} + {d}_{2} {s}^{2} + {d}_{1} s + {d}_{0}} \qquad ( 19 )$$

In equation (19), each of nᵢ (i=0, 1, 2) and dⱼ (j=0, 1, 2, 3, 4) is a coefficient derived by solving equations (13), (16) to (18) simultaneously. Therefore, at least a part of nᵢ or dⱼ includes the speed V component of the vehicle body 2, and thus the value thereof changes according to the speed V.

Considering a process of deriving the transmission function as described above, transmission characteristics represented by the transmission function of equation (19) represent the relationship between the torque Tₘ of the drive motor 13 and the acceleration x_{b}″ of the vehicle body 2, which is caused by the elasticity of the carcass portion 162b of the tire 162 and the viscosity of the tread 162a of the tire 162, and the viscoelasticity of the suspension device 18.

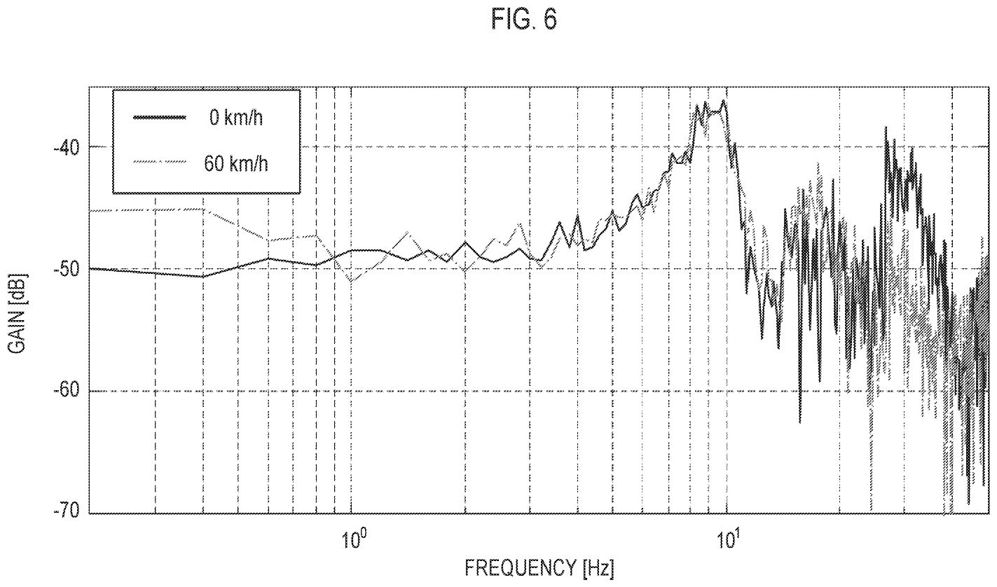

In order to confirm the validity of the models defined by equation (13) and equations (16) to (18), that is, the validity of the transmission characteristics of equation (19), frequency response characteristics in an experimental vehicle and frequency response characteristics according to equation (19) are compared. FIG. 6 is a diagram showing actual measurement values of the frequency response characteristics in the experimental vehicle when the speed V is 0 km/h and 60 km/h. The gain in FIG. 6 represents a ratio of the acceleration x_{b}″ of the vehicle body 2 to the torque Tₘ of the drive motor 13. As can be seen from FIG. 6, peak values of solely resonances near 30 Hz among a plurality of resonances change according to the speed of the vehicle in the actual measurement in the experimental vehicle.

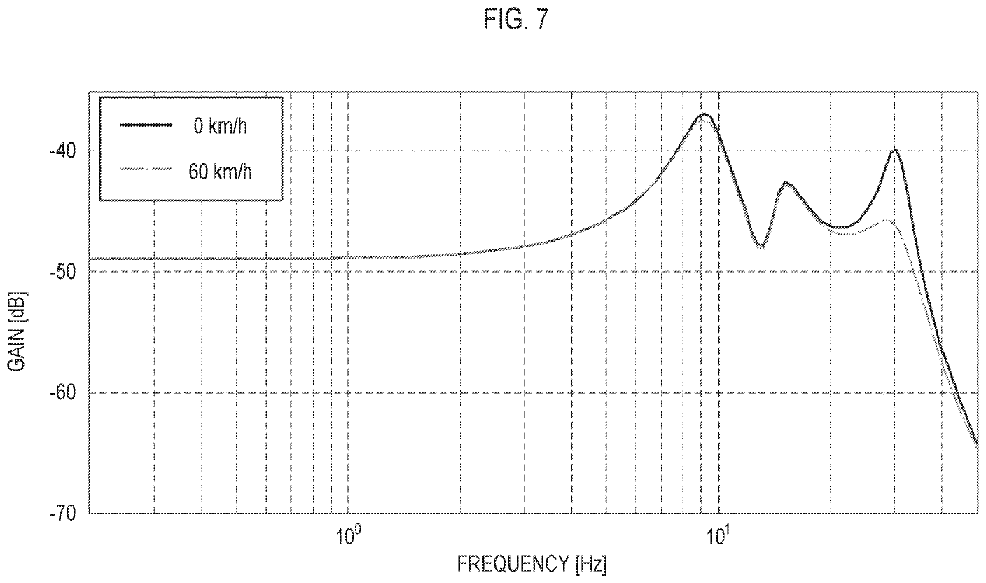

FIG. 7 is a diagram representing the transmission characteristics represented by equation (19) as the frequency response characteristics when the speed V is 0 km/h and 60 km/h. In the frequency response characteristics of FIG. 7, in addition to a rigid body mode of the suspension device 18 near 8 Hz and a rigid body mode of the tire near 30 Hz, a rigid body mode due to viscoelasticity of an engine mount near 16 Hz is added (this is because the experimental vehicle used for the measurement to obtain the frequency response characteristic of FIG. 6 is an in-wheel motor hybrid vehicle and is equipped with an internal combustion engine for electric power generation).

As can be seen from FIG. 7, the gain changes according to the speed V of the electrified vehicle 1 in the frequency region near 30 Hz, also in the transmission characteristics represented by equation (19). This is a change caused by using the physical model considering the viscoelasticity of the tire 162 described above. When FIG. 6 and FIG. 7 are compared, the gain near 30 Hz changes in the same manner according to the speed V of the vehicle in both cases. Therefore, the transmission characteristics represented by equation (19) can be found to appropriately express the characteristics in the experimental vehicle. In particular, when FIG. 6 and FIG. 7 are referred to, the speed dependency of the electrified vehicle 1 due to the viscoelasticity of the tire is remarkably observed in the high frequency region near 30 Hz. Therefore, the transmission characteristics represented by equation (19) can be found to appropriately simulate the speed dependency of the electrified vehicle 1 due to viscoelasticity of the tire.

The torque command value calculation unit 232 of the ECU 20 removes, from an input signal, a frequency component in which the vibration becomes large due to the viscoelasticity of the tire 162 (gain becomes large in FIG. 7) using the transmission characteristics represented by equation (19) to suppress the vibration. In particular, in the present embodiment, the torque command value calculation unit 232 gives, to the input signal, characteristics in which the denominator and the numerator of equation (19) are exchanged, that is, inverse characteristics of the transmission characteristics represented by equation (19) to suppress the vibration. Specifically, the torque command value calculation unit 232 inputs the torque target value Tₘₜ to a function of the following equation (20) representing the inverse characteristics of the transmission characteristics that represent the relationship between the torque of the drive motor 13 and the acceleration of the vehicle body 2 to calculate the torque command value Tₘᵢ.

$${T}_{mi} = \frac{{d}_{4} {s}^{4} + {d}_{3} {s}^{3} + {d}_{2} {s}^{2} + {d}_{1} s + {d}_{0}}{{n}_{2} {s}^{2} + {n}_{1} s + {n}_{0}} {T}_{mt} \qquad ( 20 )$$

However, equation (20) is a non-proper transmission function in which the order of s in the numerator is higher than the order of s in the denominator, and such characteristics cannot actually exist. In the present embodiment, the torque command value calculation unit 232 is provided with a second-order low-pass filter of the complex parameter s, which makes the inverse characteristics represented by equation (20) proper, to align the orders of the denominator and the numerator. Therefore, the torque command value calculation unit 232 inputs the torque target value to a function obtained by multiplying equation (20) by a function representing the second-order low-pass filter to calculate the torque command value.

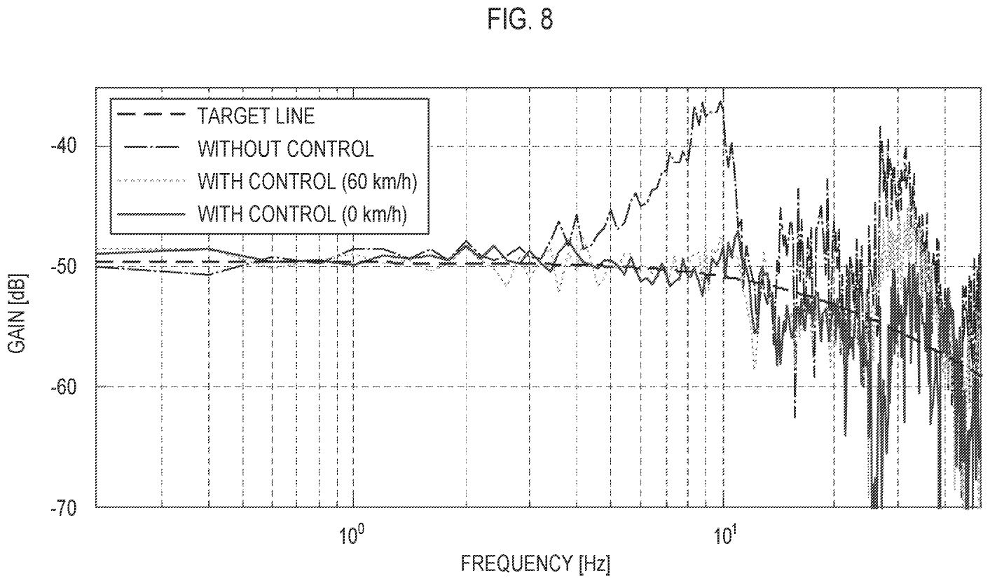

A result of an experiment performed using the experimental vehicle for the suppression of the vibration by the control device according to the present embodiment is shown. FIG. 8 is a diagram showing frequency response characteristics representing the result of the experiment. In the experiment, the experimental vehicle is stopped (speed V=0 km/h). A dark broken line in FIG. 8 indicates a target line of the frequency response characteristics, and the experimental vehicle is designed to have the frequency response characteristics along this target line.

An alternate long and short dash line in FIG. 8 represents actual measurement values of the frequency response characteristics when the vibration is not suppressed by the control device according to the present embodiment, that is, when the torque command value calculation unit 232 outputs the same value as the torque target value as the torque command value. A broken line in FIG. 8 represents actual measurement values of the frequency response characteristics when the vibration is suppressed by the control device according to the present embodiment assuming that the speed V of the electrified vehicle 1 is 60 km/h (different from an actual speed), that is, when the torque command value calculation unit 232 calculates the torque command value Tₘᵢ by equation (20) assuming that the speed V of the electrified vehicle 1 is 60 km/h. A solid line in FIG. 8 represents actual measurement values of the frequency response characteristics when the vibration is suppressed by the control device according to the present embodiment assuming that the speed V of the electrified vehicle 1 is 0 km/h (same as an actual speed), that is, when the torque command value calculation unit 232 calculates the torque command value Tₘᵢ by equation (20) assuming that the speed V of the electrified vehicle 1 is 0 km/h.

As can be seen from FIG. 8, the solid line (vibration suppression control with the speed of 0 km/h) is closer to the target line than the broken line (vibration suppression control with the speed of 60 km/h), particularly near 30 Hz. Therefore, confirmation is made that the vibration suppression effect is high when the vibration suppression control is performed using the transmission characteristics at the same speed as the actual speed V of the electrified vehicle 1 (solid line), as compared with when the vibration suppression control is performed using the transmission characteristics at the speed different from the actual speed V of the electrified vehicle 1 (broken line). Therefore, according to the present embodiment, it is possible to suppress the vibration of the electrified vehicle 1 depending on the speed of the electrified vehicle 1 due to the viscoelasticity of the tire.

### Modification Example

The transmission characteristics represented by the transmission function of equation (19) represent the relationship between the torque Tₘ of the drive motor 13 and the acceleration x_{b}″ of the vehicle body 2, which is caused by the viscoelasticity of the suspension device 18 in addition to the elasticity of the carcass portion 162b of the tire 162 and the viscosity of the tread 162a of the tire 162. Therefore, in the above embodiment, the torque command value calculation unit 232 uses the function representing the inverse characteristics of the transmission characteristics caused by both the viscoelasticity of the tire 162 and the viscoelasticity of the suspension device 18 to calculate the torque command value based on the torque target value.

However, the torque command value calculation unit 232 may use a transmission function other than the transmission function derived based on equation (13) and equations (16) to (18) when the function representing the inverse characteristics of the transmission characteristics caused by the viscoelasticity in the tire 162 is used. Therefore, the torque command value calculation unit 232 may use a function representing the inverse characteristics of the transmission characteristics, which is caused by the viscoelasticity of the tire 162 but is not caused by the viscoelasticity of the suspension device 18. In this case, the torque command value calculation unit 232 uses the transmission function derived based on equations (13) and (16). The transmission function in this case can also be represented as in equation (19), but a part of nᵢ and dⱼ becomes zero. Also in this case, at least a part of non-zero nᵢ or dⱼ includes the speed V component of the vehicle body 2, and thus the value thereof changes according to the speed V. Alternatively, the torque command value calculation unit 232 may use a function representing the inverse characteristics of the transmission characteristics, which is caused by another factor (for example, the elasticity of the drive shaft when the drive shaft is long) in addition to the viscoelasticity of the tire 162, or the viscoelasticity of the tire 162 and the viscoelasticity of the suspension device 18.

Although embodiments of the present disclosure have been described above, an applicable embodiment of the present disclosure is not limited to these embodiments, and various changes and modifications can be made within the scope of the claims.

What is claimed is:

1. A control device for an electrified vehicle that controls a drive motor configured to drive a tire-wheel assembly based on a torque target value set based on a state of a vehicle, the control device comprising:
a torque command value calculation unit that calculates a torque command value based on the torque target value using a function representing inverse characteristics of transmission characteristics that represent a relationship between torque of the drive motor and acceleration of a vehicle body and that change according to a speed of the vehicle, which is caused by elasticity of a carcass portion of a tire of the tire-wheel assembly and viscosity in a tread of the tire; and
a motor controller that controls the drive motor to output torque corresponding to the torque command value.

2. The control device according to claim 1, wherein:
the transmission characteristics represent the relationship between the torque of the drive motor and the acceleration of the vehicle body, which is caused by viscoelasticity of a suspension device between the vehicle body and the tire-wheel assembly in addition to the elasticity in the carcass portion of the tire and the viscosity in the tread of the tire.

3. The control device according to claim 1, wherein:
a relationship between torque Tₘ of the drive motor and acceleration x_{b}″ of the vehicle body in the transmission characteristics is represented by the following equation 1,
$$\frac{{\ddot{x}}_{b}}{{T}_{m}} = \frac{{n}_{2} {s}^{2} + {n}_{1} s + {n}_{0}}{{d}_{4} {s}^{4} + {d}_{3} {s}^{3} + {d}_{2} {s}^{2} + {d}_{1} s + {d}_{0}} \qquad ( 1 )$$
in equation (1), s is a complex parameter of the Laplace transform, nᵢ (i=0, 1, 2) and dⱼ (j=0, 1, 2, 3, 4) are coefficients, and at least a part of nᵢ or dⱼ changes according to the speed of the vehicle, and
the coefficients nᵢ and dⱼ in equation 1 are calculated based on the following equations 2 and 3,
$$\begin{matrix}{F}_{d} = - {D}_{s} ( \frac{1}{1 + \frac{{D}_{s}}{V {k}_{c}} s} ) \frac{( \dot{x} - {\dot{x}}_{w} )}{V} & ( 2 ) \\ {I}_{w} {\ddot{θ}}_{w} = {T}_{m} - {F}_{d} & ( 3 )\end{matrix}$$
in equations 2 and 3, F_{d} is driving force of the tire, Dₛ is driving stiffness of the tire, V is a speed of a vehicle, x′−x_{w}′ is a relative speed of a tread surface with respect to a wheel fixing portion of the tire, I_{w} is moment of inertia of the tire-wheel assembly, and θ_{w}″ is angular acceleration of the tire-wheel assembly.

4. The control device according to claim 3, wherein:
the coefficients nᵢ and dᵢ in equation 1 are calculated based on the following equations 4 and 5 in addition to equations 2 and 3,
mᵤ\ddot{x}ᵤ=F_{d}−Kₓ(xᵤ−x_{b})−Cₓ(\dot{x}ᵤ−\dot{x}_{b}) (4)
m_{b}\ddot{x}_{b}=Kₓ(xᵤ−x_{b})+Cₓ(\dot{x}ᵤ−\dot{x}_{b}) (5)
in equations (4) and (5), mᵤ is a weight of an unsprung portion, m_{b} is a weight of a vehicle body, Kₓ is an elastic coefficient of a suspension device between the vehicle body and the tire, Cₓ is a viscosity coefficient of the suspension device, xᵤ, xᵤ′, and xᵤ″ are a displacement, a speed, and acceleration of the unsprung portion, respectively, and x_{b}, x_{b}′, and x_{b}″ are a displacement, a speed, and acceleration of the vehicle body, respectively.

5. The control device according to claim 1, wherein:
the inverse characteristics are represented by the following equation 6 representing the relationship between the torque target value Tₘₜ and the torque command value Tₘᵢ,
$${T}_{mi} = \frac{{d}_{4} {s}^{4} + {d}_{3} {s}^{3} + {d}_{2} {s}^{2} + {d}_{1} s + {d}_{0}}{{n}_{2} {s}^{2} + {n}_{1} s + {n}_{0}} {T}_{mt} \qquad ( 6 )$$
in equation 6, s is a complex parameter of the Laplace transform, nᵢ (i=0, 1, 2) and dⱼ (j=0, 1, 2, 3, 4) are coefficients, and at least a part of nᵢ or dⱼ changes according to the speed of the vehicle; and
the torque command value calculation unit inputs the torque target value into a function obtained by multiplying equation 6 by a second-order low-pass filter of the complex parameter s that makes the inverse characteristics represented by equation 6 proper to calculate the torque command value.
